(19) United States
(12) Patent Application Publication
(10) Pub. No.: US 2017/0300211 A1
(43) Pub. Date: Oct. 19, 2017

(54) METHOD AND APPARATUS FOR DISPLAYING STATUS INFORMATION OF APPLICATION

(71) Applicant: Beijing Xiaomi Mobile Software Co., Ltd., Beijing (CN)

(72) Inventors: Shuo WANG, Beijing (CN); Dongya JIANG, Beijing (CN); Guangjian WANG, Beijing (CN)

(21) Appl. No.: 15/339,937

(22) Filed: Nov. 1, 2016

(30) Foreign Application Priority Data
Apr. 13, 2016 (CN) 201610227324.8

(51) Int. Cl. G06F 3/0481; H04L 29/08; G06F 3/0484

(52) U.S. Cl. CPC G06F 3/04817; G06F 3/04842; H04L 67/26

(57) ABSTRACT

A method and an apparatus for displaying status information of an application are provided. The method includes: displaying an application interface of an application running in the foreground; obtaining status information of the application, the status information of the application comprising at least one type of status information; and displaying a floating icon on the application interface of the application, in which a display area of the floating icon comprises the status information of the application. By displaying, in the display area of the floating icon, the status information of the application currently running in the foreground, a user may directly obtain the status information of the application via the floating icon, thereby reducing the steps of obtaining the status information of the application and improving the efficiency of obtaining the status information of the application.

### CROSS-REFERENCE TO RELATED APPLICATIONS

This application is based on and claims priority to Chinese Patent Application No. 201610227324.8, filed on Apr. 13, 2016, the entire contents of which are incorporated herein by reference.

### FIELD

The present disclosure relates to the terminal technology field, and more particularly, to a method and an apparatus for displaying status information of an application.

### BACKGROUND

An intelligent terminal may be installed with various applications, and respective applications have different running states during the running process. For example, an application occupies memory space, consumes battery power, and uploads or downloads data, etc. Different running states correspond to different status information. For example, the status information of the application may include the occupied memory space, the power consumption and the network access speed. The status information enables a user to learn all aspects of the running state of the application.

Typically, the status information of the application is usually displayed in a relevant interface of a system setting. For example, in the iOS8 system, the user obtains the power consumption of the application through the following steps: clicking system settings, selecting a usage option in the displayed system setting interface, and choosing battery usage in a display interface of the usage option, such that battery usage percentage of the application is displayed in a display interface of the battery usage.

### SUMMARY

Embodiments of the present disclosure provide a method and an apparatus for displaying status information of an application.

According to a first aspect of embodiments of the present disclosure, there is provided a method for displaying status information of an application. The method includes: displaying an application interface of an application running in the foreground; obtaining status information of the application, the status information of the application including at least one type of status information; and displaying a floating icon on the application interface of the application, wherein the status information of the application is contained in a display area of the floating icon.

According to a second aspect of embodiments of the present disclosure, there is provided an apparatus for displaying status information of an application. The apparatus includes a processor, and a memory configured to store instructions executable by the processor, in which the processor is configured to: display an application interface of an application running in the foreground; obtain status information of the application, the status information of the application including at least one type of status information; and display a floating icon on the application interface of the application, wherein the status information of the application is contained in a display area of the floating icon.

According a third aspect of embodiments of the present disclosure, there is provided a non-transitory computer readable storage medium having stored therein instructions that, when executed by a processor of a terminal, cause the terminal to perform a method for displaying status information of an application described in the first aspect of the present disclosure.

It is to be understood that both the foregoing general description and the following detailed description are exemplary and explanatory only and are not restrictive of the disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a flow chart showing a method for displaying status information of an application according to an exemplary embodiment;

FIG. 2 is a flow chart showing a method for displaying status information of an application according to an exemplary embodiment;

FIG. 3 is a schematic diagram illustrating displaying status information of an application according to an exemplary embodiment;

FIG. 4 is a block diagram of an apparatus for displaying status information of an application according to an exemplary embodiment;

FIG. 5 is a block diagram of an apparatus for displaying status information of an application according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods consistent with aspects related to the disclosure as recited in the appended claims.

FIG. 1 is a flow chart of a method for displaying status information of an application according to an exemplary embodiment. As shown in FIG. 1, the method is applied to a terminal, and includes the following steps.

In step 101, an application interface of an application currently running in the foreground is displayed.

In step 102, status information of the application is obtained, and the status information of the application includes at least one type of status information.

In step 103, a floating icon is displayed on the application interface of the application, and the status information of the application is contained in a display area of the floating icon.

With the method according to embodiments of the present disclosure, by displaying, in the display area of the floating icon, the status information of the application currently running in the foreground, a user may directly obtain the status information of the application via the floating icon, thereby reducing the steps of obtaining the status information of the application and improving the efficiency of obtaining the status information of the application.

In some embodiments, the step of obtaining the status information of the application includes: obtaining, via a first designated port, the status information matching a type of status information to be displayed, based on the type of status information to be displayed; or obtaining a notification message of the application and determining the notification message as the status information of the application.

In some embodiments, the step of obtaining the notification message of the application includes: accessing, via a second designated port, a message reminder function of a system, and obtaining the notification message of the application when the message reminder function contains the notification message pushed by the application; or receiving the notification message written by the application via a third designated port.

In some embodiments, the step of displaying the floating icon on the application interface of the application includes: displaying first status information in the display area of the floating icon when the status information of the application includes multiple types of status information; and switching the first status information to second status information when a click operation on the floating icon is detected.

In some embodiments, after displaying the floating icon on the application interface of the application, the method further includes: obtaining new status information of the application at specified time intervals; and displaying the new status information of the application in the display area of the floating icon.

In some embodiments, after displaying the floating icon on the application interface of the application, the method further includes: stopping displaying the status information of the application in the display area of the floating icon, when it is detected that the application starts running in the background or stops running.

All the alternative embodiments may be combined, which will not be elaborated.

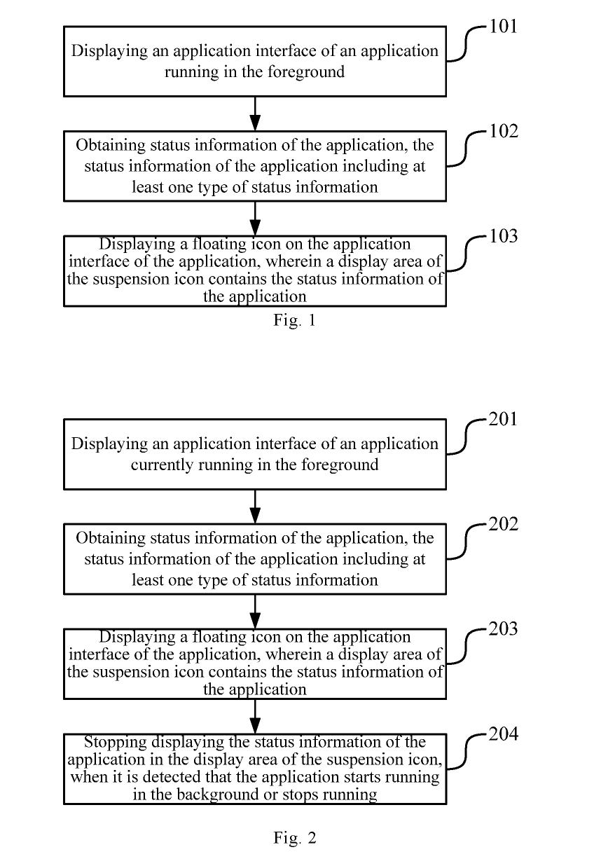

FIG. 2 is a flow chart showing a method for displaying status information of an application according to an exemplary embodiment. As shown in FIG. 2, the method is applied to a terminal, and includes the following steps.

In step 201, an application interface of an application currently running in the foreground is displayed.

In some embodiments of the present disclosure, the terminal may be installed with various applications, and each application may run in the foreground or in the background. When the application runs in the foreground, the terminal will display the application interface of the application currently running in the foreground. The application interface of the application may occupy an entire display screen of the terminal, or may occupy a part of the display screen. For example, when the terminal starts a single-hand operation mode, the application interface may occupy a part of the entire display screen of the terminal, such that the user may conveniently operate the application interface with one hand. The embodiments of the present disclosure do not specify the size of the application interface.

In step 202, status information of the application is obtained, and the status information of the application includes at least one type of status information.

In some embodiments of the present disclosure, the status information of the application is used to indicate different states of the application in the running process. For example, the status information of the application may include different types of status information, such as memory usage percentage, battery usage percentage, network uploading speed and network downloading speed of the application, to provide the user with a comprehensive understanding of the running state of the application. The terminal may compute different types of status information according to performance parameters of different aspects of the application, for example, computing the memory usage percentage of the application based on the memory space occupied by the application, computing the battery usage percentage of the application based on the battery consumption of the application, and computing the network uploading speed of the application based on the amount of data uploaded per second.

Further, in the running process of the application, a server may push various notification messages to the application, for example, a notification message of reminding a new message received in a social application, or a notification message of reminding a new function in a web application. In order to enable the user to obtain more information of the application, in embodiments of the present disclosure, the notification message pushed by the server may be obtained and considered as the status information of the application, for subsequent displaying of this notification message.

Specifically, the process of obtaining the status information of the application may will be detailed below.

In some embodiments, status information matching a type of status information to be displayed is obtained via a first designated port, based on the type of status information to be displayed.

That is, the status information has a plurality of different types. It is possible to obtain corresponding status information according to the type of status information. Since the application includes different types of status information, the type of status information to be displayed may be set in advance, to provide the user with targeted displaying service. Specifically, option buttons for different types of status information may be displayed in a setting interface of the application, and when it is detected that any type of status information is selected, the selected type of status information is determined as the type of status information to be displayed.

The first designated port is configured to access status information of different applications in the terminal, and to obtain the status information matching the type of status information to be displayed based on the type of status information to be displayed. The first designated port may be built in an operating system of the terminal, or may be added by a developer in secondary development based on the original operating system, which will not be defined in embodiments of the present disclosure.

In some embodiments, the notification message of the application is obtained and determined as the status information of the application.

The notification message of the application may be pushed to the terminal by the server, or may be obtained from the server by the terminal when it is detected that the application starts running in the foreground, which will not be defined in embodiments of the present disclosure.

Specifically, the notification message of the application may be obtained in various ways.

In some embodiments, a message reminder function of the system is accessed via a second designated port, and the notification message of the application is obtained when the message reminder function contains the notification message pushed by the application.

The second designated port is configured to access the message reminder function of the system, and the message reminder function is used to receive notification messages of different applications pushed by the server.

Specifically, the message reminder function may store the receive notification messages in a notification message list. The terminal may periodically access the notification message list via the second designated port, and obtain the notification message of the application when it is detected that the notification message list contains the notification message pushed by the application. The notification message of the application may be deleted from the notification message list after being obtained, so as to avoid repeated acquisition of the same notification information of the application in the subsequent process. Certainly, in order to avoid repeated acquisition of the notification message of the application, a timestamp may be added to each notification message. The latest timestamp is recorded after the notification message of the application is obtained, and afterwards, only notification messages after the latest timestamp are obtained for subsequent acquisition of the notification message of the application.

In some embodiments, the notification message written by the application is received via a third designated port.

The third designated port is configured to receive the notification message written by different application in the terminal.

That is, the application may actively write the notification message to be displayed into a floating icon. Specifically, after the terminal obtains the notification message of the application from the server, the application may write the obtained notification message into a predetermined storage space via the third designated port. The floating icon reads the notification message in the predetermined storage space and displays the notification message in a display area, such that the floating icon may display the notification message of the application. The content of the notification message may contain text, links or the like, which will not be defined in embodiments of the present disclosure.

It should be noted that, when the application writes the notification message via the third designated port, the notification message matching a type of notification message to be displayed may be obtained based on the type of notification message to be displayed, and afterwards, the notification message matching the type of notification message to be displayed is written into the display area of the floating icon. The type of notification message to be displayed may be set in advance.

It should be noted that, the first designated port, the second designated port and the third designated port may be the same port, or may be different ports, which will not be defined in embodiments of the present disclosure.

In step 203, the floating icon is displayed on the application interface of the application, and the display area of the floating icon contains the status information of the application.

The floating icon is displayed in suspension on the application interface of the application. The floating icon has mobility. That is, when it is detected that a movement operation is applied on the floating icon, the floating icon is controlled to move as locations indicated by the movement operation, till the movement operation ends, and the floating icon is positioned at a location where the movement operation ends. The shape of the floating icon may be a circle, a rectangle, a rounded rectangle, an oval or the like, which will not be defined in embodiments of the present disclosure.

In addition, the floating icon occupies the display area of a predetermined size, and the display area of the floating icon is used to display the status information of the application. That is, the status information of the application is contained in the display area of the floating icon. The predetermined size is set in a way that would not affect displaying of other information on the application interface. Specifically, the predetermined size may be set in proportion to a display size of the application interface, for example, occupying 2%, 5% or the like of the display size of the application interface, which will not be defined in embodiments of the present disclosure.

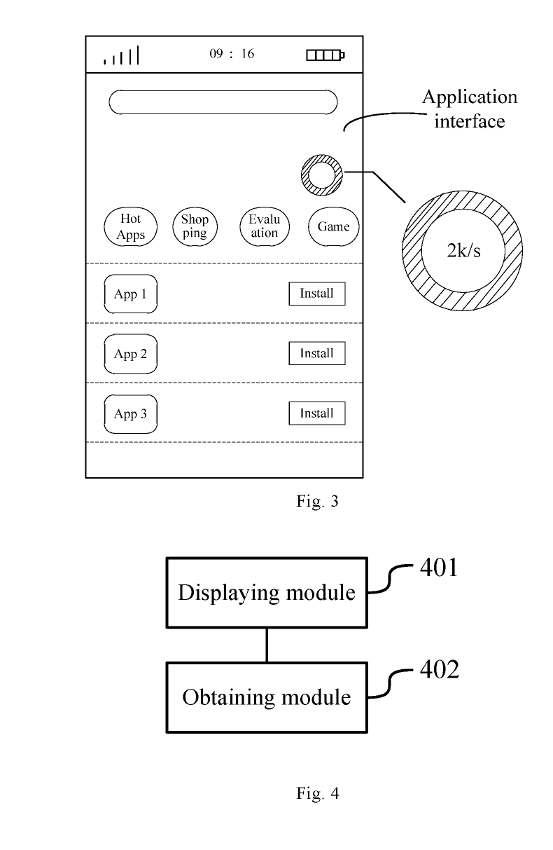

After the status information of the application is obtained, the status information of the application may be displayed in the display area of the floating icon, such that the user may directly obtain the status information of the application via the floating icon, thereby reducing the steps of obtaining the status information of the application and improving the efficiency of obtaining the status information of the application. As shown in FIG. 3, a schematic diagram for displaying status information of an application is presented, in which the floating icon is displayed on the application interface of this application. The network uploading speed is taken as an example, and it is shown in the display area of the floating icon that the current network uploading speed of this application is 2 k/s.

In some embodiments of the present disclosure, in order to improve diversity of the displaying, the display area of the floating icon may display one type of status information or various types of status information. On the application interface of the application, displaying the floating icon includes: displaying first status information in the display area of the floating icon when the status information of the application includes multiple types of status information; and switching the first status information to second status information when a click operation on the floating icon is detected.

The first status information and the second status information are of different types.

For example, the status information of the application includes A type of status information and B type of status information. After the two types of status information are obtained, A type of status information is first displayed in the display area of the floating icon. When it is detected that the click operation is applied on the floating icon, A type of status information is switched to B type of status information, that is, B type of status information is displayed in the display area of the floating icon. When the click operation on the floating icon is detected again, B type of status information is switched to A type of status information. That is, various types of status information may be switched for displaying according to the click operation on the floating icon.

In another embodiment, various types of status information may be switched automatically for displaying. Specifically, it is possible to set a switching interval for status information, i.e. to switch into a different type of status information at switching intervals. The switching interval may be set by the system or preset by the user, which will not be defined in embodiments of the present disclosure.

It should be noted that, when the status information of the application is the notification message of the application, a function of deleting the notification message may be provided. For example, when a specified operation on the floating icon is detected, a detail page of the notification message is accessed, or a corresponding link is opened, such that the notification message is no longer displayed in the display area of the floating icon. This means that the user has dealt with the notification message and hence avoids resource waste for keeping displaying the notification message. The specified operation may be an upward movement operation to a movable sliding block.

In some embodiments of the present disclosure, the status information of the application may vary all the time, and the terminal may obtain and display the status information of the application in real time, such that the user may learn the latest status information of the application. The detailed process may include: obtaining new status information of the application at specified time intervals; and displaying the new status information of the application in the display area of the floating icon.

It should be noted that the display area of the floating icon may further include a movable area. For example, a movable sliding block is provided in the center of the display area of the floating icon, and the movable sliding block may move inside the display area of the floating icon. The terminal may respond accordingly to different operations on the movable sliding block.

In step 204, the displaying of the status information of the application in the display area of the floating icon is stopped, when it is detected that the application starts running in the background or stops running.

In some embodiments of the present disclosure, the floating icon only displays the status information of the application currently running in the foreground, and does not display status information of applications that run in the background or are not running. That is, when it is detected that the application starts running in the background or when it is detected that the application stops running, the display area of the floating icon stops displaying the status information of the application.

It should be noted that when the application starts running in the background or stops running, the process from step 201 to step 203 is executed if the terminal detects another application starts running in the foreground.

In another embodiment, if the user is only concerned about the running state of a certain application when using the terminal, the application to be displayed may be set. Then, when it is detected that the application to be displayed starts running in the foreground, status information of the application to be displayed is displayed by the floating icon, which provides targeted displaying of the status information of the application.

With the method according to embodiments of the present disclosure, by displaying, in the display area of the floating icon, the status information of the application currently running in the foreground, the user may directly obtain the status information of the application via the floating icon, thereby reducing the steps of obtaining the status information of the application and improving the efficiency of obtaining the status information of the application.

FIG. 4 is a block diagram of an apparatus for displaying status information of an application according to an exemplary embodiment. Referring to FIG. 4, the apparatus includes a displaying module 401 and an obtaining module 402.

The displaying module 401 is connected with the obtaining module 402, and configured to display an application interface of an application running in the foreground. The obtaining module 402 is configured to obtain status information of the application, and the status information of the application includes at least one type of status information. The displaying module 401 is further configured to display a floating icon on the application interface of the application, and the status information of the application is contained in a display area of the floating icon.

In some embodiments, the obtaining module 402 is configured to obtain the status information matching a type of status information to be displayed via a first designated port, based on the type of status information to be displayed; or the obtaining module 402 is configured to obtain a notification message of the application and determine the notification message as the status information of the application.

In some embodiments, the obtaining module 402 is configured to access a message reminder function of a system via a second designated port, and obtain the notification message of the application when the message reminder function contains the notification message pushed by the application; or the obtaining module 402 is configured to receive the notification message written by the application via a third designated port.

In some embodiments, the displaying module 401 is configured to display first status information in the display area of the floating icon when the status information of the application includes multiple types of status information; and switch the first status information to second status information when a click operation on the floating icon is detected.

In some embodiments, the obtaining module 402 is further configured to obtain new status information of the application at specified time intervals; and the displaying module 401 is further configured to display the new status information of the application in the display area of the floating icon.

In some embodiments, the displaying module 401 is further configured to stop displaying the status information of the application in the display area of the floating icon, when it is detected that the application starts running in the background or stops running.

With the apparatus according to embodiments of the present disclosure, by displaying, in the display area of the floating icon, the status information of the application currently running in the foreground, the user may directly obtain the status information of the application via the floating icon, thereby reducing the steps of obtaining the status information of the application and improving the efficiency of obtaining the status information of the application.

With respect to the apparatuses in the above embodiments, the specific manners for performing operations for individual modules therein have been described in detail in the embodiments regarding the methods for displaying status information of the application, which will not be elaborated herein.

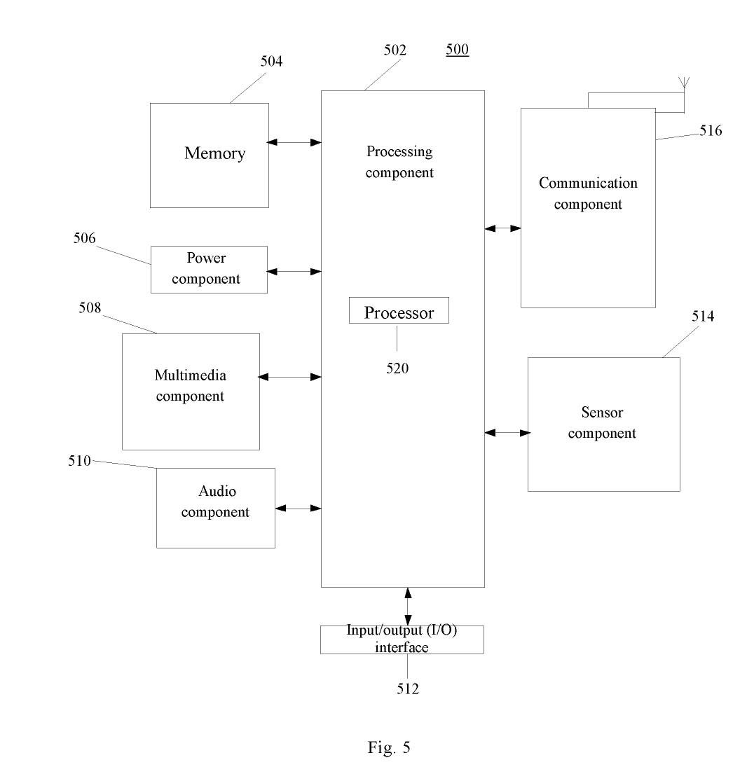

FIG. 5 is a block diagram of an apparatus for displaying status information of an application according to an exemplary embodiment. For example, the apparatus 500 may be a mobile phone, a personal computer, a digital broadcast terminal, a messaging device, a gaming console, a tablet, a medical device, exercise equipment, a personal digital assistant, and the like.

Referring to FIG. 5, the apparatus 500 may include one or more of the following components: a processing component 502, a memory 504, a power component 506, a multimedia component 508, an audio component 510, an input/output (I/O) interface 512, a sensor component 514, and a communication component 516.

The processing component 502 typically controls overall operations of the apparatus 500, such as the operations associated with display, telephone calls, data communications, camera operations, and recording operations. The processing component 502 may include one or more processors 520 to execute instructions to perform all or part of the steps in the above described methods. Moreover, the processing component 502 may include one or more modules which facilitate the interaction between the processing component 502 and other components. For instance, the processing component 502 may include a multimedia module to facilitate the interaction between the multimedia component 508 and the processing component 502.

The memory 504 is configured to store various types of data to support the operation of the apparatus 500. Examples of such data include instructions for any applications or methods operated on the apparatus 500, contact data, phonebook data, messages, pictures, video, etc. The memory 504 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 506 provides power to various components of the apparatus 500. The power component 506 may include a power management system, one or more power sources, and any other components associated with the generation, management, and distribution of power in the apparatus 500.

The multimedia component 508 includes a screen providing an output interface between the apparatus 500 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 508 includes a front camera and/or a rear camera. The front camera and the rear camera may receive an external multimedia data while the apparatus 500 is in an operation mode, such as a photographing mode or a video mode. Each of the front camera and the rear camera may be a fixed optical lens system or have focus and optical zoom capability.

The audio component 510 is configured to output and/or input audio signals. For example, the audio component 510 includes a microphone (“MIC”) configured to receive an external audio signal when the apparatus 500 is in an operation mode, such as a call mode, a recording mode, and a voice recognition mode. The received audio signal may be further stored in the memory 504 or transmitted via the communication component 516. In some embodiments, the audio component 510 further includes a speaker to output audio signals.

The I/O interface 512 provides an interface between the processing component 502 and peripheral interface modules, such as a keyboard, a click wheel, buttons, and the like. The buttons may include, but are not limited to, a home button, a volume button, a starting button, and a locking button.

The sensor component 514 includes one or more sensors to provide status assessments of various aspects of the apparatus 500. For instance, the sensor component 514 may detect an open/closed status of the apparatus 500, relative positioning of components, e.g., the display and the keypad, of the apparatus 500, a change in position of the apparatus 500 or a component of the apparatus 500, a presence or absence of user contact with the apparatus 500, an orientation or an acceleration/deceleration of the apparatus 500, and a change in temperature of the apparatus 500. The sensor component 514 may include a proximity sensor configured to detect the presence of nearby objects without any physical contact. The sensor component 514 may also include a light sensor, such as a CMOS or CCD image sensor, for use in imaging applications. In some embodiments, the sensor component 514 may also include an accelerometer sensor, a gyroscope sensor, a magnetic sensor, a pressure sensor, or a temperature sensor.

The communication component 516 is configured to facilitate communication, wired or wirelessly, between the apparatus 500 and other devices. The apparatus 500 can access a wireless network based on a communication standard, such as WiFi, 2G or 3G, or a combination thereof. In one exemplary embodiment, the communication component 516 receives a broadcast signal or broadcast associated information from an external broadcast management system via a broadcast channel. In one exemplary embodiment, the communication component 516 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the apparatus 500 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 504, executable by the processor 520 in the apparatus 500, for performing the above-described methods. For example, the non-transitory computer-readable storage medium may be a ROM, a RAM, a CD-ROM, a magnetic tape, a floppy disc, an optical data storage device, and the like.

In exemplary embodiments, a non-transitory computer-readable storage medium is further provided. The storage medium has stored therein instructions that, when executed by a processor of the mobile terminal, cause the mobile terminal to perform the method for displaying status information of the application.

Other embodiments of the present disclosure will be apparent to those skilled in the art from consideration of the specification and practice of the disclosure disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for displaying status information of an application, comprising:
displaying an application interface of an application running in the foreground;
obtaining status information of the application, the status information of the application comprising at least one type of status information; and
displaying a floating icon on the application interface of the application, wherein the status information of the application is contained in a display area of the floating icon.

2. The method according to claim 1, wherein obtaining status information of the application comprises:
obtaining, via a first designated port, the status information matching a type of status information to be displayed, based on the type of status information to be displayed.

3. The method according to claim 1, wherein obtaining status information of the application comprises:
obtaining a notification message of the application and determining the notification message as the status information of the application.

4. The method according to claim 3, wherein obtaining a notification message of the application comprises:
accessing, via a second designated port, a message reminder function of a system, and obtaining the notification message of the application when the message reminder function contains the notification message pushed by the application.

5. The method according to claim 3, wherein obtaining a notification message of the application comprises:
receiving, via a third designated port, the notification message written by the application.

6. The method according to claim 1, wherein displaying a floating icon on the application interface of the application comprises:
displaying first status information in the display area of the floating icon when the status information of the application comprises multiple types of status information; and
switching the first status information to second status information when a click operation on the floating icon is detected.

7. The method according to claim 1, after displaying a floating icon on the application interface of the application, further comprising:
obtaining new status information of the application at specified time intervals; and
displaying the new status information of the application in the display area of the floating icon.

8. The method according to claim 1, after displaying a floating icon on the application interface of the application, further comprising:
stopping displaying the status information of the application in the display area of the floating icon, when it is detected that the application starts running in the background or stops running.

9. An apparatus for displaying status information of an application, comprising:
a processor;
a memory configured to store instructions executable by the processor;
wherein the processor is configured to:
display an application interface of an application running in the foreground;
obtain status information of the application, the status information of the application at least one type of status information; and
display a floating icon on the application interface of the application, wherein the status information of the application is contained in a display area of the floating icon.

10. The apparatus according to claim 9, wherein the processor is configured to obtain, via a first designated port, the status information matching a type of status information to be displayed, based on the type of status information to be displayed.

11. The apparatus according to claim 9, wherein the processor is configured to obtain a notification message of the application and to determine the notification message as the status information of the application.

12. The apparatus according to claim 11, wherein the processor is configured to access, via a second designated port, a message reminder function of a system, and obtain the notification message of the application when the message reminder function contains the notification message pushed by the application.

13. The apparatus according to claim 11, wherein the processor is configured to receive, via a third designated port, the notification message written by the application.

14. The apparatus according to claim 9, wherein the processor is configured to display first status information in the display area of the floating icon when the status information of the application comprises multiple types of status information; and switch the first status information to second status information when a click operation on the floating icon is detected.

15. The apparatus according to claim 9, wherein the processor is further configured to obtain new status information of the application at specified time intervals; and display the new status information of the application in the display area of the floating icon.

16. The apparatus according to claim 9, wherein the processor is further configured to stop displaying the status information of the application in the display area of the floating icon, when it is detected that the application starts running in the background or stops running.

17. A non-transitory computer readable storage medium having stored therein instructions that, when executed by a processor of a terminal, cause the terminal to perform a method for displaying status information of an application, the method comprising:
displaying an application interface of an application running in the foreground;
obtaining status information of the application, the status information of the application comprising at least one type of status information; and
displaying a floating icon on the application interface of the application, wherein the status information of the application is contained in a display area of the floating icon.
